(19) United States
(12) Patent Application Publication
(10) Pub. No.: US 2009/0274932 A1
(43) Pub. Date: Nov. 5, 2009

(54) Sputtered metal film recording medium including texture promotion layer

(75) Inventors: Mallika Kamarajugadda, Eden Prairie, MN (US); Jixiong Han, Woodbury, MN (US); Joseph Skorjanec, White Bear Lake, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 12/150,980

(22) Filed: May 2, 2008

(51) Int. Cl. G11B 5/66; B05D 5/12

(52) U.S. Cl. 428/831.2; 427/129

(57) ABSTRACT

A sputtered metal film recording medium includes a substrate, a texture promotion layer sputtered on a first side of the substrate, a seed layer deposited on the texture promotion layer, an intermediate layer including a chromium alloy deposited on the seed layer, and a longitudinal magnetic recording layer including a cobalt alloy deposited on the intermediate layer. The texture promotion layer configures in-plane orientation of a cobalt structure in the magnetic recording layer.

### THE FIELD

Embodiments generally relate to sputtered metal film recording media, and more particularly, to plasma deposited layers that are configured to improve texture and signal-to-noise ratio in longitudinal sputtered metal film magnetic recording media.

### BACKGROUND

Magnetic recording media include multiple layers of thin films deposited on a substrate. One form of magnetic recording media includes sputtered metal film layers deposited as a thin film stack, where the layers are sequentially coated on the substrate to provide a recording film. One or more of the upper layers include one or more magnetic thin film recording layers that are configured for information storage.

The magnetic thin film recording layer(s) exhibit a hexagonal close-packed (hcp) crystal structure having an “easy” axis of magnetization along a “c” direction of the hcp structure. A crystallographic direction is defined in which the c axis corresponds to the <00.1> direction in the hcp structure. For longitudinal recording applications, it is desired that the <00.1> axis be oriented in the plane of the film. Conventionally, this orientation is achieved by depositing the thin film stack at temperatures between 200-300 degrees Celsius to promote the growth of either a chromium (Cr) (200) or Cr (112) crystal structure in a plane parallel to the film plane. Chromium-based underlayers with Cr (200) or Cr (112) texture promotes the development of Co (11.0) and/or Co (10.0) texture in the subsequently deposited upper magnetic layers. The Co (10.0) texture is more desirable as it does not result in the formation of “bi-crystal” grains that tend to be strongly exchange coupled. Unfortunately, chromium-based layers deposited at room temperature generally grow with predominately (110) texture that results in (10.1) growth in the magnetic layer. As a consequence, the desirable cobalt easy-axis crystal structure <00.1> is tilted out of the plane of the magnetic recording layer by about thirty degrees, thus resulting in less desirable recording properties.

Manufacturers and consumers of magnetic recording media desire improved magnetic information storage media having improved recording properties.

### SUMMARY

One aspect provides a sputtered metal film recording medium. The sputtered metal film recording medium includes a substrate, a texture promotion layer sputtered on a first side of the substrate, a seed layer deposited on the texture promotion layer, an intermediate layer including a chromium alloy deposited on the seed layer, and a longitudinal magnetic recording layer including a cobalt alloy deposited on the intermediate layer. The texture promotion layer configures in-plane orientation of a cobalt structure in the magnetic recording layer.

One aspect provides a magnetic recording medium including a longitudinal recording film having a multi-layer magnetic recording stack including a magnetic recording layer deposited on a substrate. The substrate includes a sputtered texture promotion layer disposed between a first surface of the substrate and the multi-layer magnetic recording stack. The texture promotion layer promotes in-plane orientation of crystal structure in the magnetic recording layer.

One aspect provides a method of fabricating recording media. The method includes providing a substrate and sputtering a texture promotion layer onto the substrate. The method additionally includes coating a multi-layer stack including a magnetic recording layer onto the texture promotion layer, and promoting in-plane orientation of crystal structure in the magnetic recording layer with the texture promotion layer.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a cross-sectional view of a sputtered metal film recording medium according to one embodiment.

FIG. 2 is a graph of X-ray diffraction data of Intensity in Counts plotted against Two-Theta for in-plane scan overlays of a variety of coatings applied to a substrate.

FIG. 3 is a graph of X-ray diffraction data of Intensity in Counts plotted against Two-Theta for in-plane scans of sputtered metal film stacks with and without a texture promotion layer according to one embodiment.

FIG. 4 is a bar graph of various substrate treatments plotted against spectral signal-to-noise-ratio (SNR).

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

These terms when used herein have the following meanings.

The term “coating composition” means a composition suitable for coating onto a substrate. The terms “layer” and “coating” are used interchangeably to refer to a coated composition, which may be the result of one or more deposition processes and one or more passages through the coating apparatus.

The term “coercivity” means the intensity of the magnetic field needed to reduce the magnetization of a ferromagnetic material to zero after it has reached saturation, taken at a saturation field strength of 10,000 Oersteds.

The term “Oersted,” abbreviated as Oe, refers to a unit of magnetic field strength in the cgs unit system.

The term “lubricant” means a substance introduced between two adjacent solid surfaces, at least one of which is capable of motion, to produce an antifriction effect between the surfaces.

The term “protective layer” means a substance applied to the magnetic layer for purposes of protecting it mechanically or chemically, and not primarily as a lubricant.

The term “direction of easy magnetization” means the magnetization direction in the crystal for which the stored crystalline anisotropy energy is minimized.

The terms “perpendicular remenance” and “parallel remenance” refer to the magnetization remaining in the thin film magnetic material after saturating the material and then reducing the applied magnetic field to zero in directions perpendicular or parallel to the thin film plane, respectively.

The terms “<abc>” and “<ab.c>” where a, b, and c are whole numbers specify crystallographic directions in cubic and hexagonal close-packed structures, while the terms “(abc)” and “(ab.c)” are Miller indices of crystallographic planes in cubic and hexagonal structures, respectively. Detailed descriptions of concepts including crystallographic directions and Miller indices can be found in a variety of references on X-ray diffraction and crystallography, which are known to those of skill in the art.

The term “texture”, when referring to a thin film indicates that the orientation of the crystallites (grains) forming the thin film is not random, but that specific film planes, typically specified by Miller indices, are preferentially arranged parallel to the film plane. For example, stating that a thin film exhibits a (110) texture means that the film has a number of crystallites with (110) crystal planes oriented parallel to the film surface.

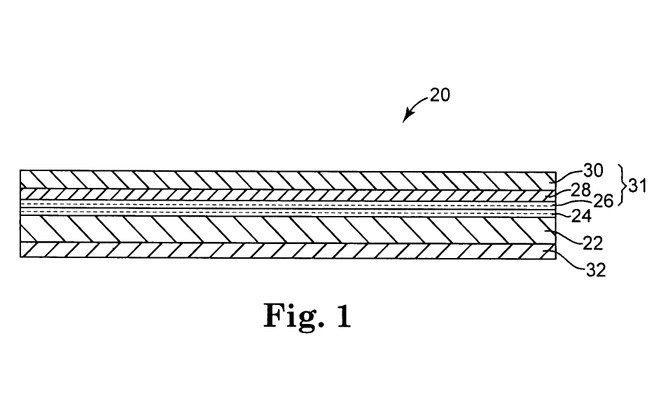

FIG. 1 is a cross-sectional view of a sputtered metal film (SMF) recording medium 20 according to one embodiment. Recording medium 20 includes a substrate 22, a texture promotion layer 24 sputtered on a first side of substrate 22, a seed layer 26 deposited on the texture promotion layer 24, an intermediate layer 28 deposited on seed layer 26, and a magnetic recording layer 30 deposited on intermediate layer 28. A magnetic recording stack 31 (or stack 31) is defined by an overlay of seed layer 26, intermediate layer 28, and magnetic recording layer 30.

Substrate 22 includes any suitable non-magnetic support material. In one embodiment, substrate 22 includes a flexible polymeric substrate having a thickness between about 4-60 micrometers. Other suitable substrates include polyethylene terephthalate, polyethylene naphthalate, polypropylene and the like, polyamides, or polyimides.

Texture promotion layer 24 is provided to configure in-plane orientation of crystallographic structure in magnetic recording layer 30. In one embodiment, texture promotion layer 24 includes a sputtered metal layer, a sputtered metal oxide layer, a sputtered nitride layer, or a sputtered carbide. In one exemplary embodiment, texture promotion layer 24 includes pure titanium sputtered from a titanium source in an argon plasma. In another exemplary embodiment, texture promotion layer 24 includes an oxide of titanium sputtered from a titanium source in an oxygen and argon plasma. When employed in a longitudinal magnetic recording medium, texture promotion layer 24 promotes the W (200) texture in seed layer 26 and the Cr (112) texture in the intermediate layer 28.

In one embodiment, seed layer 26 is deposited onto texture promotion layer 24 at a thickness of no greater than about 10 nanometers, for example, by sputtering. In one embodiment, seed layer 26 is a tungsten seed layer 26 having a thickness of between about 2-10 nanometers, preferably from about 2-8 nanometers, and more preferably tungsten seed layer 26 has a thickness of between about 4-6 nanometers. In one embodiment, tungsten seed layer 26 is configured to alter the crystallographic texture of subsequently deposited chromium-based alloy intermediate layer 28.

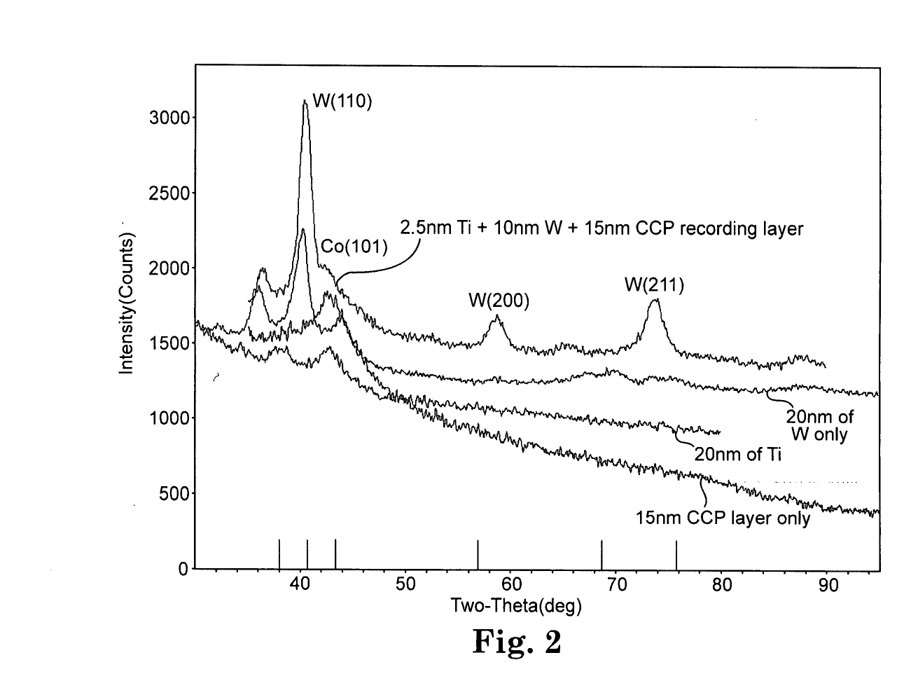

Specifically, in one embodiment texture promoting layer 24 promotes the desirable texture of the tungsten seed layer 26, which in turn reduces the chromium (110) and (200) textures and increases the more desirable chromium (112) texture. The change in chromium texture beneficially alters the texture of the subsequently deposited cobalt-chromium-platinum (CoCrPt, which is represented by CCP in FIG. 2)) alloy magnetic layer. For example, the CoCrPt (10.1) texture is reduced, and the more desirable CoCrPt (10.0) and Co(11.0) textures are increased.

Sputtered metal media deposited at room temperature generally exhibit little grain boundary segregation and are consequently tightly exchange coupled, which is undesirable for recording applications as it greatly increases media transition noise. Seed layer 26 employing Body Centered Cubic (BCC) materials, such as W, deposited on texture promoting layers is effective at improving orientation in CoCrPt layers, including layers doped with SiO₂. In one embodiment, the texture promoting layer 24 includes one of a hcp or an amorphous layer and the seed layer includes a BCC seed layer configured to promote the in-plane orientation of the Co based magnetic recording layer.

In one embodiment, intermediate layer 28 includes an alloy of chromium, tungsten, and a third element selected from titanium, vanadium, manganese, or tantalum. In one embodiment, intermediate layer 28 includes an alloy of chromium, titanium, and tungsten, where the alloy includes between about 5-25 percent tungsten and between 5-10 percent titanium.

A chromium-based underlayer or intermediate layer deposited at room temperature directly on a substrate typically promotes growth of the chromium (110) texture which promotes growth of a (10.1) texture in the subsequently-coated magnetic recording layer. Consequently, the easy axis of magnetization is tilted out of the film plane by about 30 degrees, resulting in less desirable recording characteristics. However, when the tungsten-containing chromium alloy intermediate layer 28 is grown a top thin tungsten seed layer 26, which in turn is grown on the texture promoting layer 24, the recording layer 30 on top of the intermediate layer 28 has the growth of crystals with (10.1) texture substantially reduced, and the growth of crystals having (10.0) planes parallel to the film plane significantly increased, even when the recording layer is deposited at room temperature.

Magnetic recording layer 30 includes a cobalt alloy of cobalt, chromium, and platinum (CoCrPt or CCP) having a hexagonal close-packed (hcp) crystal structure. In one embodiment, magnetic recording layer 30 includes a cobalt alloy modified to include a compound that promotes grain segregation. For example, in one embodiment, magnetic recording layer 30 includes a CoCrPt alloy modified to include SiO₂ or boron to enhance grain segregation in the magnetic recording layer 30.

The crystallographic alignment of the thin film recording layer determines, to a large extent, the characteristics and quality of magnetic recording layer 30. The crystallites (grains) of the Co-alloy recording layer 30 have one axis of magnetization known as the easy axis of magnetization that corresponds to the <00.1> crystallographic direction in the hexagonal close packed structure. In devices that utilize longitudinal recording such as magnetic recording tapes and other direct access storage devices, the easy axis of magnetization is preferably parallel to the film substrate 22.

In one embodiment, SMF recording medium 20 optionally includes a backing 32 deposited or otherwise coated onto substrate 22 opposite texture promotion layer 24. Suitable backings 32 include non-magnetic backings having a lubricant or other additive to minimize friction of recording medium 20 as it passes through a drive or other reading device.

SMF recording medium 20 has in-plane (parallel to the plane of the deposited film) coercivities of at least about 2500 Oe, preferably at least about 2800 Oe, and in one embodiment, as much as 3000 Oe, and provides improved magnetic properties.

### An Exemplary Method of Manufacture

In one embodiment, recording media is fabricated by sputtering a titanium alloy texture promotion layer 24 onto substrate 22, sputtering a tungsten seed layer 26 onto texture promotion layer 24, coating intermediate layer 28 and magnetic recording layer 30 onto seed layer 26, and promoting in-plane orientation of structure in magnetic recording layer 30 with the texture promotion layer 24. An optional protective coating of, for example (but not limited to), diamond-like carbon may be deposited by a suitable method after deposition of the magnetic layer(s). The protective coating protects against corrosion, or increases durability, or both. When employed, useful protective layers may include such materials as diamond-like carbon layers, SiC layers, amorphous carbon, nitrogenated or hydrogenated amorphous carbon, or silicon nitride.

When all the layers have been coated onto substrate 22, finishing processes such as polishing or burnishing may be performed. A lubricant layer may be applied by known methods. For example, the lubricant compound may be dissolved in a solvent, and the thin film medium dipped in the lubricant solution for a sufficient time to allow the solution to contact the surface, and then drained, or the lubricant solution may be pumped over the recording medium and then allowed to drain. The lubricant may be any conventional lubricant known in the industry, e.g., a fluorinated hydrocarbon, or, more specifically, a fluorinated polyether.

### EXAMPLES

Exemplary embodiments were fabricated and evaluated from glass substrates and plastic substrates.

Sputtered film deposition was performed in a Magnetic Coupon Coater (MCC), a multi-target sputtering machine that can co-sputter materials from up to nine target materials. Base pressure of the system prior to deposition was <10₇ Torr. Titanium was sputtered at 5 mTorr, while the other layers were sputtered at 10 mTorr. Deposition was done in one of an argon atmosphere or an argon and oxygen atmosphere at a working gas pressure of 10 mTorr. The tungsten (W) seed layer 26 was deposited from an elemental W target, while the W-containing intermediate layer 28 and magnetic layer 30 were deposited by co-sputtering alloy targets. For example, suitable magnetic layers were deposited either from an alloy CoCr₁₈Pt₂₂ target or co-sputtered from a CoCr₁₀ and elemental Pt target. In one embodiment, the composition of the co-sputtered magnetic layer was CoCr₈Pt₂₃. All composition values refer to atomic percent.

SiO₂ was added to the magnetic layer on several samples to reduce intergranular exchange coupling. Deposition of all metallic layers was accomplished using DC magnetron sputtering. For samples employing SiO₂-doped CoCrPt magnetic layers, an amorphous SiO₂ target was co-sputtered with the magnetic materials using a RF magnetron. Deposition of SiOx doped CoCrPt was also done using a composite CoCrPt (SiOx) alloy target.

In another example, deposition was performed in a Magnetic Roll Coater (MRC) deposition system having multiple targets and configured to deposit multiple layers sequentially. Base pressure of the system prior to deposition was ˜10⁷ Torr. Titanium was sputtered at 3 mTorr, while the other layers were sputtered at 18 mTorr. Deposition was done in one of an argon atmosphere at a working gas pressure of 18 mTorr. The tungsten (W) seed layer 26 was deposited from an elemental W target, while the W-containing intermediate layer 28 and magnetic layer 30 were deposited from alloy targets. In one embodiment, the composition of the magnetic layer was CoCr₁₈Pt₂₃(SiO2). All composition values refer to atomic percent.

Magnetic characterization of the samples was accomplished using an Alternating Gradient Magnetometer (AGM) (Princeton Measurements Corporation Micromag® 2900). Structural characterization of the samples was performed using both in-plane and Bragg diffraction methods, for example, with a theta-2theta X-ray diffractometer and Cu Kα radiation (Rigaku® RINT 2000).

FIG. 2 is a graph of X-ray diffraction data of Intensity in Counts plotted against Two-Theta for in-plane scan overlays of a variety of coatings applied to a substrate. FIG. 2 represents in-plane scan overlays of a 15 nm CCP layer only, a 20 nm titanium layer only, a 20 nm tungsten layer only, and a recording medium according to embodiments described above including 2.5 nm of titanium and 10 nm of tungsten followed by 15 nm of magnetic recording layer 30. The overlay of the data illustrates the texture promotion that is provided by a single layer of titanium deposited on substrate 22 prior to deposition of stack 31 (FIG. 1). Magnetic recording medium 20 includes a significant tungsten W (200) peak and a significant W (211) peak. Thus, even a thin layer of a titanium texture promotion layer 24 promotes significant tungsten W (200) texture.

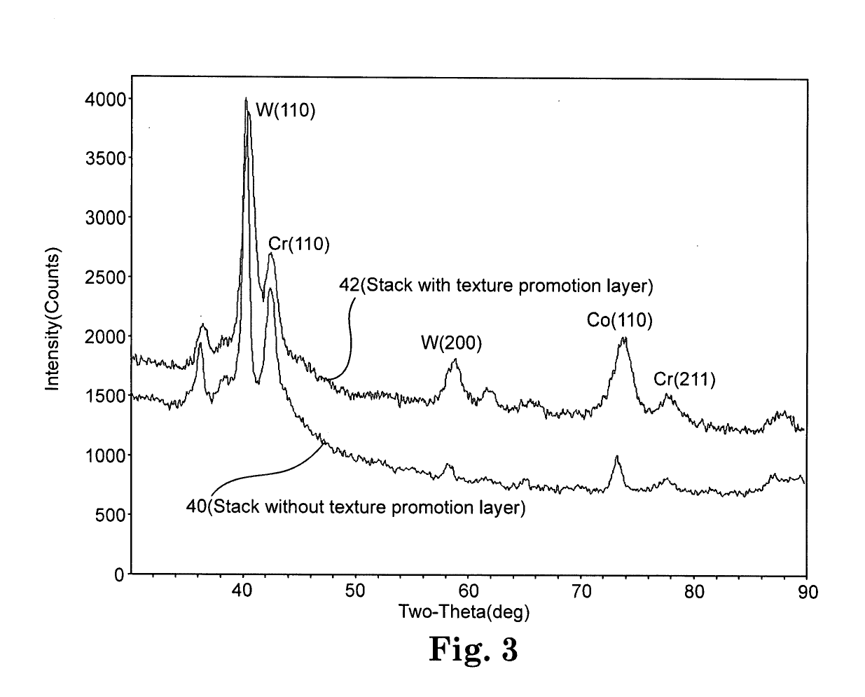

FIG. 3 is a graph of X-ray diffraction data of Intensity in Counts plotted against Two-Theta for in-plane scans of sputtered metal film stacks with and without a texture promotion layer according to one embodiment. Data set 40 (curve 40) represents a standard magnetic recording multi-layered sputtered metal film stack without a texture promotion layer. Data set 42 (curve 42) represents magnetic recording medium 20 including texture promotion layer 24.

Data set 40 includes few peaks and little or no desirable texture in the seed layer or the magnetic recording layer. In contrast, data set 42 having texture promotion layer 24 includes significant W (200) and Co (10) peaks, indicating that W (200) is promoting cobalt (110) and cobalt (100), both of which contribute to in-plane orientation of cobalt. In other words, titanium texture promotion layer 24 significantly improves in-plane orientation of cobalt in the magnetic recording layer 30.

It has also been discovered that treating substrate 22 with texture promotion layer 24 reduces clustering of grains and uniformly distributes grain structure of subsequently applied magnetic recording layers. In one embodiment, texture promotion layer 24 enables SiO₂ added to the CoCrPt-magnetic layer 30 alloy to beneficially separate grains in the magnetic recording layer structure. The SMF stack 31 (FIG. 1) exhibits a decrease in cluster size and has improved grain size distribution when substrate 22 is first coated with texture promotion layer 24.

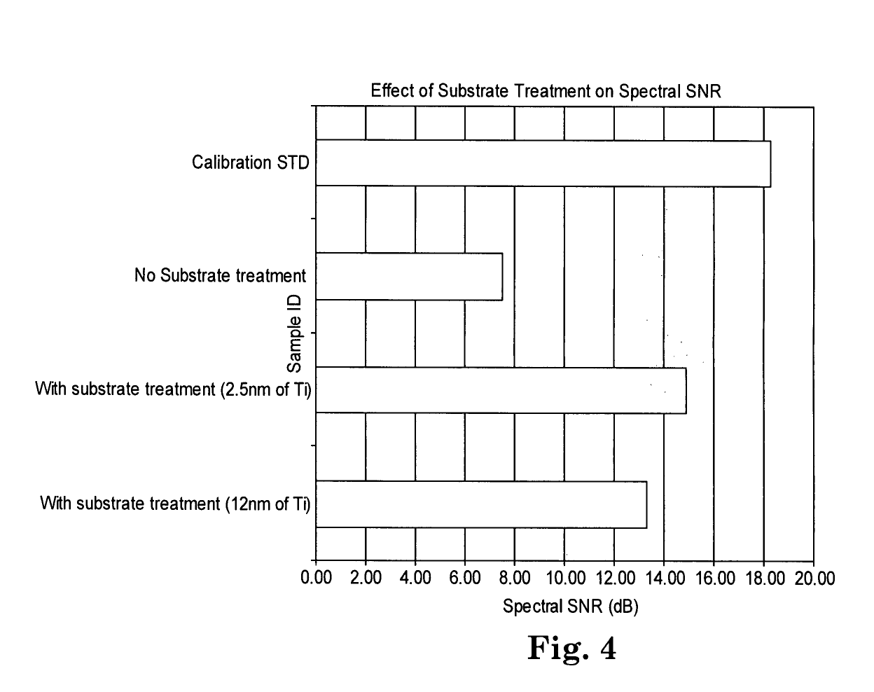

FIG. 4 is a bar graph of various substrate treatments plotted against spectral signal-to-noise-ratio (SNR) according to one embodiment. The topmost bar provides a calibration standard against which sputtered magnetic recording media is compared. A conventional magnetic recording medium having no substrate treatment (a control sample) has a spectral SNR of about 6.9 dB. A magnetic recording media according to embodiments described herein including about 2.5 nm of a titanium texture promotion layer 24 has nearly double the value of spectral SNR, which is about 14.7 dB. Thus, employing texture promotion layer 24 as a substrate treatment improves the spectral signal-to-noise-ratio (SNR) by about 5 dB.

A similar magnetic recording medium 20 including about 12 nm of a titanium texture promotion layer 24 also has a significant increase in spectral SNR when compared to the control sample having no substrate treatment. FIG. 4 represents that for a wide range of texture promotion layer thicknesses, spectral SNR is significantly improved in comparison to the control sample having no texture promotion layer.

Embodiments provide a magnetic recording medium suited for use in a removable data storage product, such as a data storage tape cartridge. Embodiments provide a magnetic recording medium having a texture promotion layer that improves recording properties and SNR. The improved SNR in the magnetic recording media also has reduced noise, which improves the recording performance.

A substrate modification is described in which thin layers of texture promotion layers applied to the substrate increase texture in a tungsten seed layer which in turn promotes desired orientation of the cobalt alloy in the magnetic recording layers. For example, embodiments provide an increase in the tungsten (200) and Cr (211), which promotes cobalt (100) and cobalt (110) that improves the longitudinal recording in the magnetic layers. In-plane orientation of cobalt (100) is improved by promotion of texture in the tungsten (200) by the texture promotion layer 24.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of sputtered metal film magnetic recording media as discussed herein.

What is claimed is:

1. A sputtered metal film recording medium comprising:
a substrate;
a texture promotion layer sputtered on a first side of the substrate;
a seed layer deposited on the texture promotion layer;
an intermediate layer comprising a chromium alloy deposited on the seed layer; and
a longitudinal magnetic recording layer comprising a cobalt alloy deposited on the intermediate layer;
wherein the texture promotion layer configures in-plane orientation of a cobalt structure in the magnetic recording layer.

2. The sputtered metal film recording medium of claim 1, wherein the seed layer comprises tungsten and the texture promotion layer promotes a W (200) texture in the tungsten seed layer which promotes a Co (100) in-plane orientation of the cobalt alloy of the magnetic recording layer.

3. The sputtered metal film recording medium of claim 1, wherein the texture promotion layer is configured to increase signal-to-noise ratio in the longitudinal magnetic recording layer by at least 5 dB.

4. The sputtered metal film recording medium of claim 1, wherein the texture promotion layer comprises one of a sputtered metal layer, a sputtered metal oxide layer, a sputtered nitride layer, and a sputtered carbide layer.

5. The sputtered metal film recording medium of claim 1, wherein the texture promotion layer comprises pure Ti sputtered from titanium in an argon plasma.

6. The sputtered metal film recording medium of claim 1, wherein the texture promotion layer comprises an oxide of titanium sputtered from titanium in an oxygen and argon plasma.

7. The sputtered metal film recording medium of claim 1, wherein the texture promoting layer comprises one of a hexagonal close-packed and an amorphous structure and the seed layer comprises a Body Centered Cubic seed layer configured to promote the in-plane orientation of the Co based magnetic recording layer.

8. The sputtered metal film recording medium of claim 1, wherein the substrate comprises one of a flexible polymeric substrate and a rigid glass substrate.

9. The sputtered metal film recording medium of claim 1, wherein the texture promotion layer comprises a thickness between about 1-40 nm.

10. The sputtered metal film recording medium of claim 1, wherein the intermediate layer comprises an alloy of chromium, titanium, and tungsten.

11. A magnetic recording medium comprising:
a longitudinal recording film comprising a multi-layer magnetic recording stack including a magnetic recording layer deposited on a substrate, the substrate comprising a sputtered texture promotion layer disposed between a first surface of the substrate and the multi-layer magnetic recording stack;
wherein the texture promotion layer promotes in-plane orientation of crystal structure in the magnetic recording layer.

12. The magnetic recording medium of claim 11, wherein the texture promotion layer promotes in-plane orientation of a hexagonal close-packed cobalt <100>crystal structure in the magnetic recording layer.

13. The magnetic recording medium of claim 11, wherein the texture promotion layer comprises pure titanium.

14. The magnetic recording medium of claim 11, wherein the texture promotion layer comprises an oxide of titanium.

15. The magnetic recording medium of claim 11, wherein the sputtered texture promotion layer is configured to increase the signal-to-noise ratio of a recording layer of the multi-layer magnetic recording stack by at least 5 dB.

16. The magnetic recording medium of claim 11, wherein the multi-layer magnetic recording stack comprises:
a tungsten seed layer disposed on the sputtered texture promotion layer;
an intermediate layer disposed on the tungsten seed layer, the intermediate layer comprising an alloy of chromium, tungsten, and titanium; and
the magnetic recording layer that comprises a cobalt alloy disposed on the intermediate layer.

17. A method of fabricating recording media, the method comprising:
providing a substrate;
sputtering a texture promotion layer onto the substrate;
coating a multi-layer stack including a magnetic recording layer onto the texture promotion layer; and
promoting in-plane orientation of crystal structure in the magnetic recording layer with the texture promotion layer.
